(19) United States
(12) Patent Application Publication
(10) Pub. No.: US 2002/0140545 A1
(43) Pub. Date: Oct. 3, 2002

(54) Integrated RKE and telematics system

(76) Inventors: Peter Nietupski, Romulus, MI (US); Timothy James Breault, Northville, MI (US); John J. Correia, Livonia, MI (US)

Correspondence Address: BRINKS HOFER GILSON & LIONE, P.O. BOX 10395, CHICAGO, IL, 60610, US

(21) Appl. No.: 09/818,376

(22) Filed: Mar. 27, 2001

Related U.S. Application Data
(60) Provisional application No. 60/226,194, filed on Aug. 18, 2000.

(51) Int. Cl. H04Q 1/00

(52) U.S. Cl. 340/5.72; 340/5.5

(57) ABSTRACT

A method and system for simplifying a vehicle interface to provide local connectivity to various vehicle systems are disclosed. The vehicle interface is simplified across many vehicle types and configurations by deploying a local wireless connection.

### CROSS REFERENCE TO RELATED APPLICATION

The present application claims priority to U.S. provisional patent application Serial No. 60/226,194 filed Aug. 18, 2000.

### FIELD OF THE INVENTION

The present invention relates to automotive telematics systems having a central response center for providing information and remote services to telematics equipped vehicles.

### BACKGROUND ART

Existing telematics solutions use four functional elements: 1) a wireless phone or some type of wireless communication device to provide a one-way or two-way connection to the public switch telephone network (PSTN), internet or other wide area network infrastructure; 2) a global positioning service (GPS) or some type of positioning solution to provide a real-time location of the device or its user; 3) a vehicle interface to provide local connectivity to various vehicle systems; and 4) a human interface to allow a user to interact with the services that are enabled by these elements.

A major consideration in the design and development of a vehicle interface that provides local connectivity to various vehicle systems is that the various vehicle systems differ greatly across vehicle types. Therefore, a need exits for a method and system for simplifying the vehicle interface across the many vehicle types and configurations. The new and improved method and system must allow remote systems to actuate various vehicle sub-systems and provide useful and value added services.

### SUMMARY OF THE INVENTION

In accordance with an aspect of the present invention a method and system is provided to simplify the vehicle interface that provides local connectivity to various vehicle systems. In a preferred embodiment of the present invention, the vehicle interface is simplified across many vehicle types and configurations by deploying a local wireless connection.

In accordance with another aspect of the present invention, a remote keyless entry system is utilized as the local wireless connection to actuate a variety of useful and value added services such as remote actuation of door locks, security systems, horn, vehicle lights, and other vehicle sub-systems.

### BRIEF DESCRIPTION OF THE DRAWINGS

FIG. 1 is a schematic diagram of a vehicle telematics system, in accordance with the present invention;

FIG. 2 is a block diagram of an in-vehicle telematics system interface that communicates with an external infrastructure to actuate various vehicle sub-systems and components, in accordance with the present invention; and

FIG. 3 is a flow diagram illustrating a method for remotely actuating various vehicle sub-systems and components using a in-vehicle wireless connection, in accordance with the present invention.

### DETAILED DESCRIPTION OF THE INVENTION

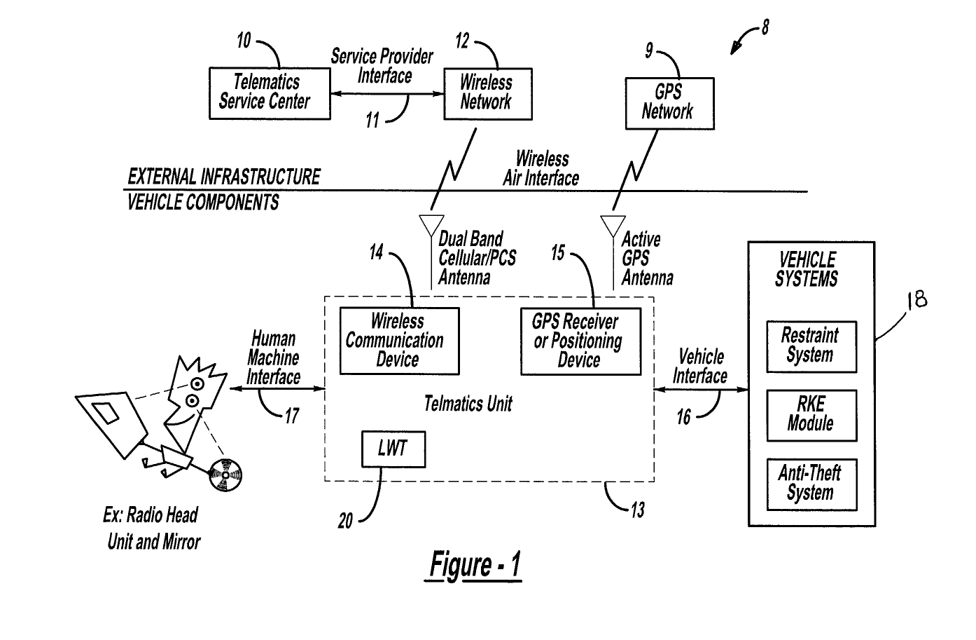

Referring now to FIG. 1, a schematic diagram of a vehicle telematics system is illustrated and generally indicated by a reference numeral 8, in accordance with the present invention. The present invention utilizes an end and service delivery system including a telematics service or response center 10. Telematics service center 10 employs a voice and/or data connection to the vehicle to deliver value added services, such as assistance for emergencies, navigational information, and concierge type functions. Preferably, telematics service center 10 is connected to a land based infrastructure 11 (e.g. the PSTN, the internet, the virtual private network (VPN)). Further provided is a wireless network 12 which provides communication between telematics service center 10, infrastructure 11 and an in-vehicle telematics control unit (TCU) 13.

To provide vehicle positioning data and other useful information to a vehicle operator, telematics control unit 13 communicates with a global positioning service (GPS) network 9. GPS network 9 is a constellation of satellites operated by the U.S. Government that provides location and time information signals. These signals allow a GPS receiver to determine an operator's exact location on earth.

In-vehicle TCU 13 includes a wireless phone 14 or some other type of wireless communication device, to provide a connection to service center 10 through wireless network 12, PSTN, internet, or other wide area network infrastructure. In-vehicle telematics control unit 13 further includes a GPS receiver 15 for communicating with the GPS network 9 to provide time and location signals for determining the position of the GPS receiver or its user. Of course, other positioning solutions such as LORAN, dead reckoning, etc. may be used to provide vehicle positioning information to a vehicle operator.

System 8 further provides a vehicle interface 16 to allow local communication between TCU 13 and the various vehicle sub-systems and components.

A human interface 17 provides the vehicle operator with a communication pathway with the plurality of services that are enabled by the telematics system. Human interface 17 and vehicle interface 16 are provided through a variety of means. Generally, human interface 17 requires a means to provide hands-free voice communication to the vehicle operator. Further, the human interface 17 allows a vehicle operator to request services from the telematics service center 10. Such means may include, for example, a service request button for requesting road side assistance or a request for navigational information. Further, human interface 17 must provide a feedback concerning system status or operating mode.

Conventional interface 16 is provided through a plurality of wired vehicle connections to provide discrete digital control and sense I/O or through the deployment of a variety of vehicle buses (such as a multiplex bus). Vehicle electrical system configurations vary widely across vehicle manufacturers and sub-system designers. This complexity, variety, and uniqueness of vehicle systems 18 from different manufacturers and vehicle models make it difficult to deploy standard methods and procedures for providing vehicle interface 16 (and related in-vehicle services). This is particularly the case for legacy and currently manufactured vehicles.

Telematics control unit 13 includes a local wireless transmitter 20 to access existing local remote access receivers. These local remote access receivers exist in many vehicles today. For example, one embodiment of the present invention utilizes the existing remote keyless entry (RKE) systems that exist in over 40% of today's vehicles. In this embodiment, a key-fob like RKE transmitter is integrated into TCU 13. Thus, the present invention allows a number of remote services to be deployed across a variety of vehicles while achieving a low system cost. These services for example, include door lock/unlock, horn actuation, vehicle interior and exterior lighting actuation, vehicle seat setting adjustments, as well as initializing or setting a variety of other vehicle parameters. All these services are performed remotely through the end to end telematics service delivery system as described above.

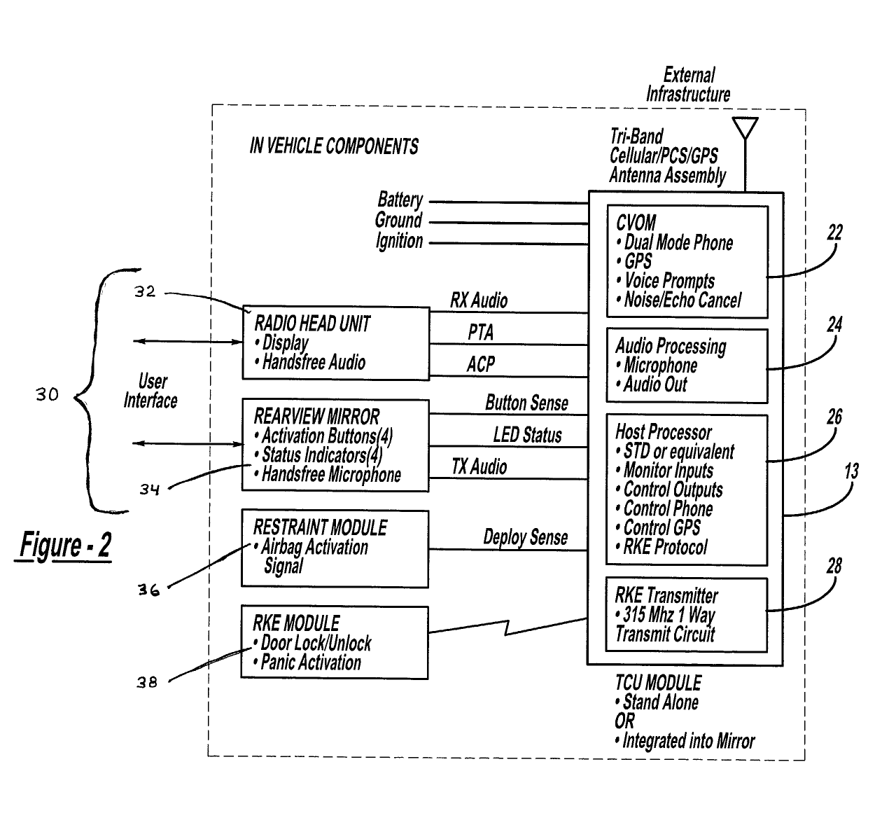

Referring now to FIG. 2, in-vehicle elements of the present invention are illustrated in greater detail. TCU 13 is an embodiment in a stand alone module and in another embodiment is integrated into a vehicle's rearview mirror. TCU 13 has a cellular/voice/data module 22, an audio processing module 24, a host processor 26, and a RKE transmitter 28. CVD module 22 supports a dual mode phone, a GPS with voice microphone support and audio out. Host processor 26 preferably is an ST9 processor or equivalent having monitor inputs, control outputs, control phone, control GPS and RKE protocol.

The TCU module 13 is in communication with a user interface 30. User interface 30 includes a radio head unit 32 and preferably includes an interactive rearview mirror 34. A vehicle operator sends and receives audio signals and other data signals from user interface 30. More specifically, user interface 30 communicates data through a PTA, ACP, button sensor, LED status lines.

Radio head unit 32 in an embodiment worn by the vehicle operator and includes a display and hands free radio to provide interactive communication with the TCU 13. In an embodiment, the rearview mirror 34 has four activation buttons, four status indicators, and a hands free microphone.

In another embodiment of the present invention, TCU 13 is in communication with a vehicle restraint module 36. TCU 13 preferably receives an airbag activation signal when the vehicle's airbag deploys. The airbag activation signal is communicated through a deploy sense line to TCU 13.

RKE transmitter 28 communicates with a conventional RKE module 38. RKE module 38, for example, controls the vehicle's door locks and panic activation and any other features which may be present. Preferably, control of RKE module 38 is initiated through transmission of infrared signals from RKE transmitter 28.

RKE transmitter 28 operates on the same frequency and with the same communication protocol as is already provided for a particular vehicle in which TCU 13 is installed. For example, RKE transmitter in one embodiment operates at 315 megahertz and uses data messages having a transmitter identification code (TIC) and an operation code. As is know in the art, the TIC is a unique number associated with the transmitter and is used to identify an authorized transmitter or key-fob for accessing various functions in a particular vehicle. Typically, an RKE receiver is pre-programmed by a vehicle manufacturer and/or the vehicle owner to include TIC's for each authorized transmitter. A plurality of operational codes are also pre-programmed to identify the desired functions (usually associated with the particular button pressed on a key-fob) such as door lock, door unlock, horn actuation, etc.

In a preferred embodiment, the present invention utilizes existing reprogramming or initialization methods for gaining authorized access to the RKE system. Authorized access to the RKE controlled functions is required to utilize TCU 13 mounted RKE transmitter 28. One method known for re-programming an existing RKE receiver is by cycling the vehicle ignition a number of times, such as eight. This causes the receiver to switch to a program mode. The new transmitter to be authorized, such as RKE transmitter 28, is programmed by pressing one of RKE functions such as door, lock or unlock. Accordingly, the present invention utilizes this same programming mode by providing a button on the TCU 13 to allow manual initialization of a transmission from TCU 13 mounted RKE transmitter 28.

In a preferred embodiment, the telematics control unit 13 monitors the vehicle ignition and triggers a special mode based on the same ignition sequence. Further, a unique button or combination of buttons or button presses may be provided on the TCU 13 to allow the user to initiate manual transmission without interfering with the sequence of programming several different key-fobs.

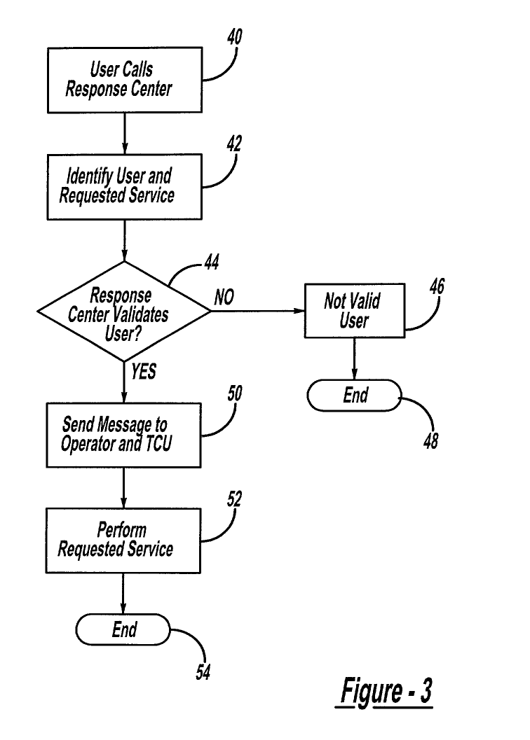

Referring now to FIG. 3, a flow chart illustrating a method for remote operation of in-vehicle RKE controlled functions by the telematics service center, in accordance with the present invention. Once the TCU mounted transmitter 28 is programmed in accordance with the method described above or with other similar methods, the remote telematics service may begin actuating in-vehicle sub-systems controlled by local wireless systems such as the RKE system. Such a method is initiated at block 40, for example, by a user calling response center 10 using for example a toll free number. The vehicle operator identifies himself and requests a desired service, as represented by block 42. At block 44, response center 10 validates the user by verifying the user's password and or other unique/private information. The system determines an appropriate message to communicate to the vehicle operator. If the system has determined that the vehicle operator has not provided a valid user ID and password, a message to that affect is sent to the vehicle, and if the user does not response with the valid password, the session ends, as represented by blocks 46 and 48. However, if the vehicle operator has responded with a valid user ID and password, an appropriate message is sent to the vehicle operator and to the telematics control unit 13 for decoding, as represented by block 50. At block 52, the RKE transmitter transmits the appropriate code to RKE receiver to command the particular vehicle sub-system or component to perform the requested service. After the requested service has been carried out and no additional requests are indicated by the vehicle operator, the current session with the response center is terminated, as represented by block 54.

Therefore, the present invention has many advantages and benefits over the prior art. For example, the present invention utilizes vehicle subsystems which are present in many vehicles today to provide value added features and services to vehicle occupants through remote wireless operation. Moreover, the present invention provides a means for a vehicle operator to access and operate vehicle subsystems from greater distances than prior art systems.

What is claimed is:

1. A method for remotely controlling a vehicle subsystem using a wireless infrastructure, the method comprising:
sending a control signal from a remotely located service center to a vehicle control unit receiver;
transmitting the control signal to a vehicle subsystem controller; and
actuating the vehicle subsystem in response to the received control signal.

2. The method of claim 1 wherein sending a control signal further comprises sending the control signal to actuate a vehicle door lock.

3. The method of claim 1 wherein sending a control signal further comprises sending the control signal to actuate a vehicle horn.

4. The method of claim 1 wherein sending a control signal further comprises sending the control signal to actuate a vehicle global positioning receiver.

5. The method of claim 1 wherein sending a control signal further comprises transmitting a radio frequency control signal to a vehicle telematics unit.

6. The method of claim 1 wherein transmitting the control signal further comprises transmitting an infrared control signal to the vehicle subsystem controller.

7. The method of claim 1 wherein the vehicle subsystem controller is a remote keyless entry system controller.

8. A system for remotely controlling a vehicle subsystem using a wireless infrastructure, the method comprising:
a remote transmitter for sending a control signal from a remotely located service center to a vehicle control unit receiver;
a in-vehicle receiver for receiving the remotely transmitted control signal; and
an in-vehicle transmitter for transmitting the control signal to a vehicle subsystem controller, and
wherein the vehicle subsystem is actuated in response to the received control signal.

9. The system of claim 8, wherein the vehicle subsystem controller is a remote keyless entry system having in infrared receiver for receiving the transmitted control signal.

10. The system of claim 8 wherein the vehicle subsystem is a vehicle door lock.

11. The system of claim 8 wherein the vehicle subsystem is a vehicle horn.

12. The system of claim 8 wherein the vehicle subsystem is a vehicle global positioning receiver.

13. A method for remotely controlling a vehicle subsystem using a wireless network infrastructure and a remote keyless entry system, the method comprising:
transmitting a control signal from a remote service center to a vehicle;
receiving the control signal, wherein the control signal is indicative of an operational state of the vehicle subsystem;
transmitting the control signal to a controller of the remote keyless entry system; and
actuating the vehicle subsystem in response to the control signal received by the controller of the remote keyless entry system.

14. The method of claim 13 wherein sending a control signal further comprises sending the control signal to actuate a vehicle door lock.

15. The method of claim 13 wherein sending a control signal further comprises sending the control signal to actuate a vehicle horn.

16. The method of claim 13 wherein sending a control signal further comprises sending the control signal to actuate a vehicle global positioning receiver.

17. The method of claim 13 wherein sending a control signal further comprises transmitting a radio frequency control signal to a vehicle telematics unit.

18. The method of claim 13 wherein transmitting the control signal further comprises transmitting an infrared control signal to the vehicle's subsystem controller.

19. A system for remotely controlling a vehicle subsystem using a wireless network infrastructure and a remote keyless entry system, the system comprising:
a remote transmitter for broadcasting a control signal from a remote service center to a vehicle;
an in-vehicle receiver for receiving the control signal, wherein the control signal is indicative of an operational state of the vehicle subsystem;
an in-vehicle transmitter transmitting the control signal to a controller of the remote keyless entry system, and
wherein the operational state of the vehicle subsystem is altered in response to the control signal received by the controller of the remote keyless entry system.

20. The system of claim 19, further comprising an operator interface for interacting with the remote service center.

21. The system of claim 20, wherein the operator interface for interacting with the remote service center is a cellular phone.

22. The system of claim 21, wherein the cellular phone has a head unit worn by a vehicle operator to communicate requests from the service center.

23. The system of claim 20, wherein the operator interface for interacting with the remote service center is an improved rear view mirror.

24. The system of claim 19, wherein the in-vehicle transmitter is an infrared transmitter for communicating with the controller of the remote keyless entry system.

25. The system of claim 19, wherein the in-vehicle receiver is an infrared receiver which is in communication with the remote keyless entry system.
